(19) United States
(12) Patent Application Publication
(10) Pub. No.: US 2025/0184508 A1
(43) Pub. Date: Jun. 5, 2025

(54) LOW COMPLEXITY ENHANCEMENT VIDEO CODING WITH SIGNAL ELEMENT MODIFICATION

(71) Applicant: V-NOVA INTERNATIONAL LIMITED, London (GB)

(72) Inventor: Richard CLUCAS, London (GB)

(21) Appl. No.: 18/852,371

(22) PCT Filed: Mar. 29, 2023
(86) PCT No.: PCT/GB2023/050818

§ 371 Date: Sep. 27, 2024

(30) Foreign Application Priority Data
Mar. 31, 2022 (GB) 2204621.3

(51) Int. Cl. H04N 19/33; H04N 19/40

(52) U.S. Cl. CPC H04N 19/33; H04N 19/40

(57) ABSTRACT

A to-be-modified signal, I₁, is modified using a modification signal, I₂, to produce a modified signal, I_{M}. The modified signal, I_{M}, has an element corresponding to an element of the to-be-modified signal, I₁. The element of the modified signal, I_{M}, has a modified value with respect to a value of the corresponding element of the to-be-modified signal, I₁. The modified signal, I_{M}, or a down-sampled modified signal derived based on down-sampling the modified signal, I_{M}, is sent to be encoded. A decoded modified signal, B_{D}, is received. The decoded modified signal, B_{D}, is a decoded version of the modified signal, I_{M}, as encoded or of the down-sampled modified signal as encoded. The decoded modified signal, B_{D}, is used to generate a processed signal, U. Residual data, R, is generated based at least on a value of an element of a target signal, I₁, and a value of a corresponding element of the processed signal, U.

### TECHNICAL FIELD

The present disclosure generally relates to scalable video coding schemes, in particular encoding and decoding schemes (e.g., codecs) having signal element modification functionality.

### BACKGROUND

An encoded video signal having scalability can be decoded (by a decoder) at different levels of quality (e.g., at different spatial dimensions). This is advantageous because it means that a single encoded video signal can be sent to many types of decoding devices (each having different operating capabilities), and each device can decode the encoded video signal in line with the operating capability of the decoder. For example, a first decoding device may only be able to decode and render an encoded video signal using a base codec whereas a second decoding device may be able to decode and render an encoded video signal using a base (or “base layer”) codec and an enhancement (or “enhancement layer”) codec. If an encoded video signal does not have scalability, then a first encoded video signal needing only the base codec would need to be sent to the first decoding device and a second encoded video signal needing both the base layer codec and the enhancement layer codec would be sent to the second decoding device. Therefore, it is desirable to have an (single) encoded video signal that can be decoded using the base codec by the first decoding device and the base and enhancement layer codecs by the second decoding device.

However, the first decoding device might, in some cases, be able to reconstruct a visually acceptable representation of an original video signal using only the base codec, albeit not one having the visual quality of a representation reconstructed using both the base and enhancement layer codecs.

This may be undesirable in terms of content protection. For example, it may be desirable that decoding using only the base codec does not produce a visually acceptable representation of the original video signal.

In addition, as explained above, it may be desirable for the second decoding device to receive the same encoded video signal as the first decoding device, but to be able to reconstruct the original video signal accurately using the same base codec as the first decoder device, as well as the enhancement layer codec.

There is thus a need for scalable video coding schemes and systems, and encoded video signals, having improved content protection.

### SUMMARY

Aspects and variations of the present invention are set out in the appended claims. Certain unclaimed aspects are further set out in the detailed description below.

### BRIEF DESCRIPTION OF THE FIGURES

FIG. 1 is a block diagram showing an example signal encoding system.

FIG. 2 is a block diagram showing an example signal decoding system.

FIG. 3 is a schematic diagram showing example signals that may be processed in the example systems shown in FIGS. 1 and 2.

FIG. 4 is a block diagram showing another example signal encoding system.

FIG. 5 is a schematic diagram showing example signals that may be processed in the example system shown in FIG. 4 and in an example signal decoding system.

FIG. 6 is a block diagram showing another example signal encoding system.

FIG. 7 is a schematic diagram showing example signals that may be processed in the example system shown in FIG. 6 and in an example signal decoding system.

FIG. 8 is a block diagram showing another example signal encoding system.

FIG. 9 is a block diagram showing another example signal encoding system.

FIG. 10 is a schematic diagram showing example signals that may be processed in the example system shown in FIG. 9 and in an example signal decoding system.

FIG. 11 is a block diagram showing another example signal encoding system.

FIG. 12 is a schematic diagram showing example signals that may be processed in the example system shown in FIG. 11 and in an example signal decoding system.

FIG. 13 is a schematic diagram showing example signals that may be processed in an example signal encoding and decoding system.

FIG. 14 is a schematic diagram showing generation of an example video bitstream.

FIG. 15 is a schematic diagram showing different portions of data that may be generated as part of an example video encoding.

FIG. 16 is a schematic diagram showing an encoding system according to an example of the present disclosure.

### DETAILED DESCRIPTION

In the detailed description below, measures are described which provide improved content protection. Such measures make it difficult or impossible for certain decoders to reconstruct accurately an original signal. Such decoders may be able to create one or more versions of the original signal, but with the version(s) having undesirable (from the perspective of a viewer) visual artefacts. Other decoders may be able to create one or more versions of the original signal without the undesirable visual artefacts and being better reconstructions of the original signal.

Without loss of generality, measures are described which modify a signal by introducing a watermark into the signal. The watermark is present, as a visual artefact, in a base layer rendition of the signal. However, the watermark is fully or substantially removed in one or more enhancement layer renditions of the signal. Without having the correct enhancement layer data to remove the watermark, the watermark appears as an undesirable visual artefact in the output signal.

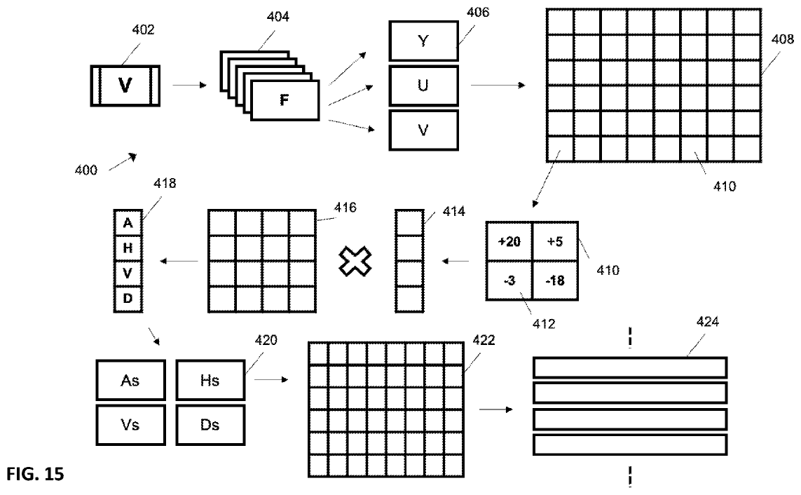

Examples are presented herein with reference to a signal as a sequence of samples (i.e., two-dimensional images, video frames, video fields, sound frames, etc.). For simplicity, non-limiting embodiments illustrated herein often refer to signals that are displayed as 2D planes of settings (e.g., 2D images in a suitable colour space), such as for instance a video signal. In a preferred case, the signal comprises a video signal. An example video signal is described in more detail with reference to FIG. 15.

The terms “picture”, “frame” or “field” will be used interchangeably with the term “image”, so as to indicate a sample in time of the video signal: any concepts and methods illustrated for video signals made of frames (progressive video signals) can be easily applicable also to video signals made of fields (interlaced video signals), and vice versa. Despite the focus of embodiments illustrated herein on image and video signals, people skilled in the art can easily understand that the same concepts and methods are also applicable to any other types of multidimensional signal (e.g., audio signals, volumetric signals, stereoscopic video signals, 3 DoF/6 DoF video signals, plenoptic signals, point clouds, etc.). Although image or video coding examples are provided, the same approaches may be applied to signals with dimensions fewer than two (e.g., audio or sensor streams) or greater than two (e.g., volumetric signals).

In the description the terms “image”, “picture” or “plane” (intended with the broadest meaning of “hyperplane”, i.e., array of elements with any number of dimensions and a given sampling grid) will be often used to identify the digital rendition of a sample of the signal along the sequence of samples, wherein each plane has a given resolution for each of its dimensions (e.g., X and Y), and comprises a set of plane elements (or “signal element”, “element”, or “pel”, or display element for two-dimensional images often called “pixel”, for volumetric images often called “voxel”, etc.) characterized by one or more “signal element values”, “values” or “settings” (e.g., by ways of non-limiting examples, colour settings in a suitable colour space, settings indicating density levels, settings indicating temperature levels, settings indicating audio pitch, settings indicating amplitude, settings indicating depth, settings indicating alpha channel transparency level, etc.). Each plane element is identified by a suitable set of coordinates, indicating the integer positions of said element in the sampling grid of the image. Signal dimensions can include only spatial dimensions (e.g., in the case of an image) or also a time dimension (e.g., in the case of a signal evolving over time, such as a video signal). In one case, a frame of a video signal may be seen to comprise a two-dimensional array with three colour component channels or a three-dimensional array with two spatial dimensions (e.g., of an indicated resolution—with lengths equal to the respective height and width of the frame) and one colour component dimension (e.g., having a length of 3). In certain cases, the processing described herein is performed individually to each plane of colour component values that make up the frame. For example, planes of pixel values representing each of Y, U, and V colour components may be processed in parallel using the methods described herein.

Certain examples described herein use a scalability framework that uses a base encoding and an enhancement encoding. The video coding systems described herein operate upon a received decoding of a base encoding (e.g., frame-by-frame or complete base encoding) and add one or more of spatial, temporal, or other quality enhancements via an enhancement layer. The base encoding may be generated by a base layer, which may use a coding scheme that differs from the enhancement layer, and in certain cases may comprise a legacy or comparative (e.g., older) coding standard.

### Example Scalable Coding Systems

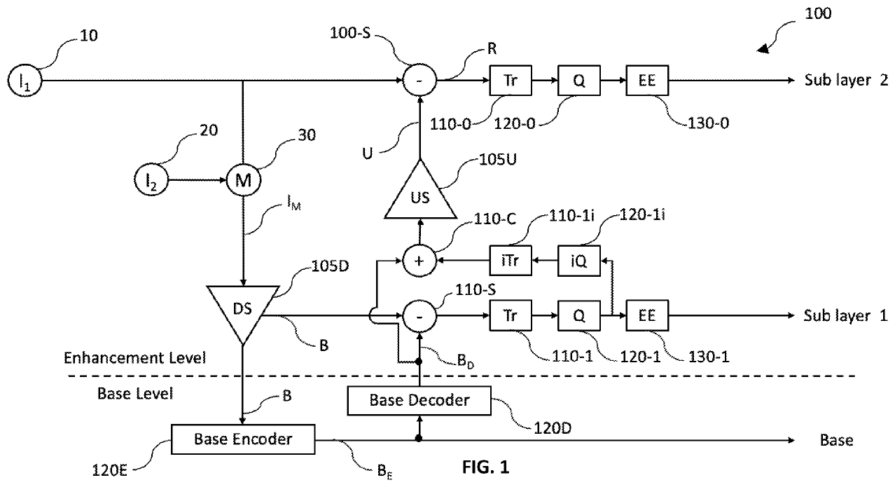

FIGS. 1, 4, 6, 8, 9 and 11 show example system configurations to implement a spatially scalable coding scheme that uses a down-sampled signal encoded with a base codec, adds a first level of correction or enhancement data to the decoded output of the base codec to generate a corrected picture, and then adds a further level of correction or enhancement data to an up-sampled version of the corrected picture. Thus, the spatially scalable coding scheme may generate an enhancement stream with two spatial resolutions (higher and lower), which may be combined with a base stream at the lower spatial resolution.

In the spatially scalable coding scheme, the methods and apparatuses may be based on an overall algorithm which is built over an existing encoding and/or decoding algorithm (e.g., MPEG standards such as AVC/H.264, HEVC/H.265, etc. as well as non-standard algorithms such as VP9, AV1, and others) which works as a baseline for an enhancement layer. The enhancement layer works according to a different encoding and/or decoding algorithm. The idea behind the overall algorithm is to encode/decode hierarchically the video frame as opposed to using block-based approaches as done in the MPEG family of algorithms. Hierarchically encoding a frame includes generating residuals for the full frame, and then a reduced or decimated frame and so on.

Various measures (such as methods, apparatuses, systems and computer programs) are described herein in which a to-be-modified signal is modified using a modification signal to produce a modified signal. The to-be-modified signal may or may not have been modified previously but is to be modified by using the modification signal. The modified signal has an element corresponding to an element of the to-be-modified signal. The elements may be corresponding in that they have the same position (e.g., coordinates) in their respective signals. The element of the modified signal has a modified value with respect to a value of the corresponding element of the to-be-modified signal. As such, the values are different from each other as a result of the modification. The modified signal, or a down-sampled modified signal derived based on down-sampling the modified signal, is sent to be encoded. This may involve sending the modified signal or the down-sampled modified signal to an encoder. A decoded modified signal is received. The decoded modified signal may be received from a decoder, which may be associated with the encoder. The decoded modified signal is a decoded version of the modified signal as encoded (i.e., by the encoder to which it is sent) or of the down-sampled modified signal as encoded (i.e., by the encoder to which it is sent). The decoded modified signal is used to generate a processed signal. Residual data is generated based at least on a value of an element of a target signal and a value of a corresponding element of the processed signal. The target signal and the processed signal may take various different forms, as will become more apparent from the below.

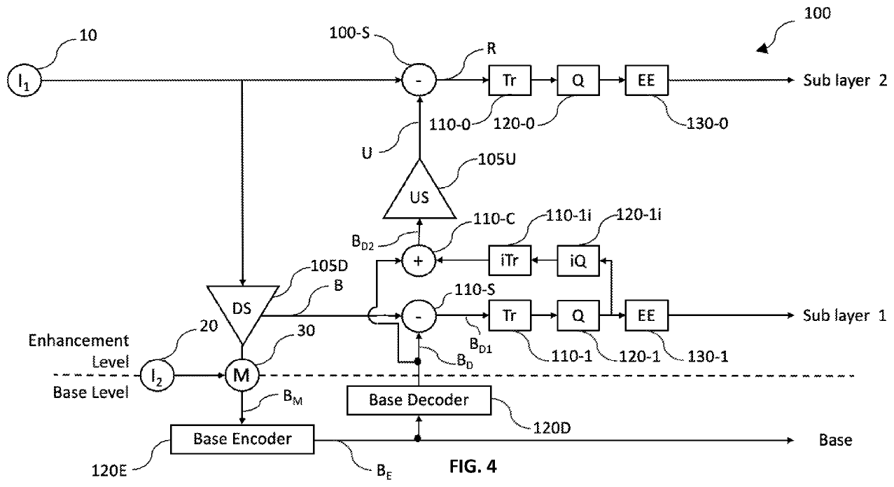

In some examples, such as described below with reference to FIGS. 1, 6, 8, 9 and 11, the modified signal is down-sampled to produce the down-sampled modified signal, and the down-sampled modified signal is sent to be encoded. In other words, in such examples, the to-be-modified signal is modified prior to down-sampling. In other examples, such as described below with reference to FIG. 4, the to-be-modified signal is modified after down-sampling.

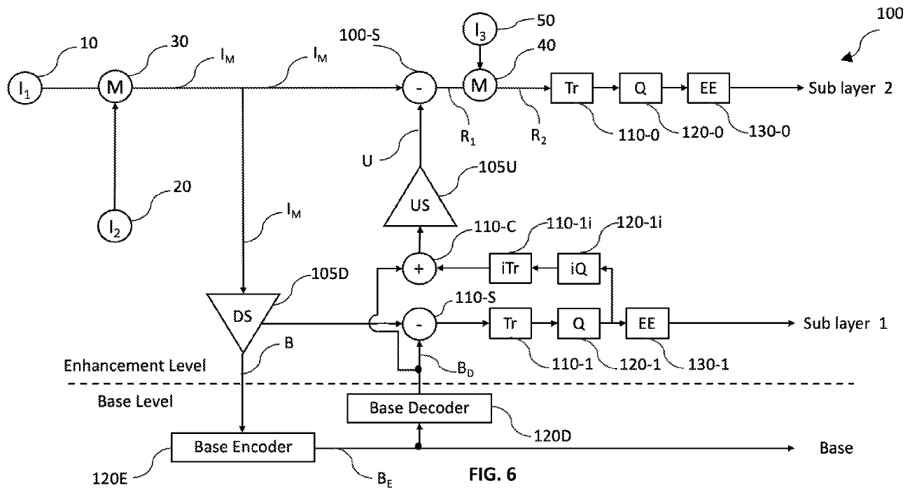

In some examples, such as described below with reference to FIGS. 1, 9 and 11, the target signal comprises the to-be-modified signal. In other examples, such as described below with reference to FIGS. 6, 8, and 9, the target signal comprises the modified signal. In other examples, such as described below with reference to FIG. 4, the target signal comprises a signal based on which the to-be-modified signal is derived.

In some examples, such as described below with reference to FIGS. 1, 4, 6, 8, 9 and 11, the residual data, or data derived based on the residual data, is sent to be encoded. The residual data, or the data derived based on the residual data, may be sent to a different encoder from an encoder to which the modified signal or the down-sampled modified signal is sent.

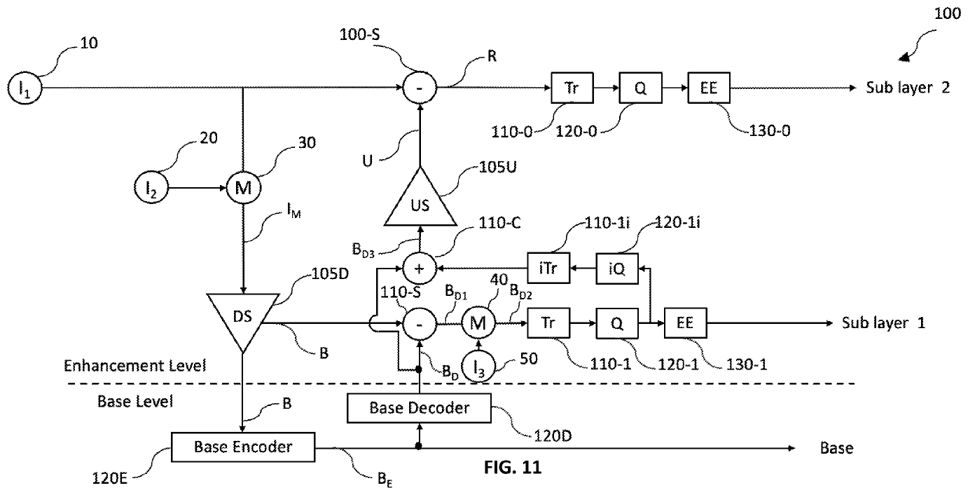

In some examples, such as described below with reference to FIG. 11, correction data is generated based on (i) a value of an element of the down-sampled modified signal, (ii) a value of a corresponding element of the decoded modified signal, and (iii) a value of a corresponding element of the modification signal or a value of a corresponding element of a signal based on the modification signal. Items (i) to (iii) may be used across one or more operations to generate the correction data.

In some examples, such as described below with reference to FIGS. 6, 9 and 11, said signal based on the modification signal is derived by processing the modification signal. Such processing may take various different forms. Examples include, but are not limited to, down-sampling and/or creating a negative (or “inverse”) version.

In some examples, such as described below with reference to FIGS. 1, 4, 6, 8, 9 and 11, (the) correction data, or data derived based on the correction data, is sent to be encoded. The correction data, or the data derived based on the correction data, may be sent to a different encoder from an encoder to which the modified signal or the down-sampled modified signal is sent.

As explained above, in some examples, such as described below with reference to FIGS. 6, 8 and 9, the target signal comprises the modified signal.

In some examples, such as described below with reference to FIGS. 6, 8 and 9, further residual data is generated based on (i) a value of an element of the residual data, and (ii) a value of a corresponding element of the modification signal or a value of a corresponding element of a signal based on the modification signal.

In some examples, such as described below with reference to FIGS. 6, 8, and 9, the further residual data, or data derived based on the further residual data, is sent to be encoded. The further residual data, or the data derived based on the further residual data, may be sent to a different encoder from an encoder to which the modified signal or the down-sampled modified signal is sent.

As explained above, in some examples, such as described below with reference to FIG. 4, the target signal comprises a to-be-down-sampled signal.

In some examples, such as described below with reference to FIG. 4, the to-be-down-sampled signal is down-sampled to derive the to-be-modified signal.

In some examples, the modification signal comprises an overlay to be applied to the to-be-modified signal. The overlay may be anything that covers, lies over, or is otherwise applied over the to-be-modified signal.

In some examples, the modification signal comprises a watermark. A watermark is a type of overlay. A watermark may comprise text (e.g. “WATERMARK”), an image, a pattern, or the like.

In some examples, the modified signal has another element corresponding to another element of the to-be-modified signal, and the other element of the modified signal has the same value as the value of the corresponding other element of the to-be-modified signal. Such other element may be considered to be an unmodified element. Unmodified elements are likely to have relatively small associated residuals, which may be more efficient to encode than larger residuals.

In some examples, the modifying of the to-be-modified signal comprises combining the to-be-modified signal with the modification signal. Such combining may take various different forms. Examples include, but are not limited to, addition-based combining, subtraction-based combining and substitution-based combining.

In some examples, the to-be-modified signal comprises a luminance component and chrominance components. The luminance component of the to-be-modified signal is modified based on the modification signal. The chrominance components of the to-be-modified signal are not modified based on the modification signal.

In some examples, the using of the decoded modified signal to generate the processed signal comprises performing an up-sampling operation.

Various measures (such as methods, apparatuses, systems and computer programs) are described herein in which a decoded modified signal is processed to obtain a processed signal the processed signal and residual data are combined to generate a reconstructed signal. The decoded modified signal is a decoded version of a modified signal as encoded or of a down-sampled modified signal as encoded. The down-sampled modified signal having been derived based on the modified signal having been down-sampled. The modified signal has been produced based on a to-be-modified signal having been modified using a modification signal. The modified signal has an element corresponding to an element of the to-be-modified signal. The element of the modified signal has a modified value with respect to a value of the corresponding element of the to-be-modified signal.

FIG. 1 shows a system configuration for an example spatially scalable encoder 100. The encoding process is split into two halves as shown by the dashed line. Below the dashed line is a base level and above the dashed line is the enhancement level, which may usefully be implemented in software. The encoder 100 may comprise only the enhancement level processes, or a combination of the base level processes and enhancement level processes as needed. The encoder 100 topology at a general level is as follows.

The encoder 100 comprises a first input 10 for receiving a first input signal I₁.

The encoder 100 comprises a second input 20 for receiving a second input signal I₂.

The encoder 100 comprises a modifier 30. The modifier 30 modifies a to-be-modified signal to generate a modified signal. The to-be-modified signal may or may not already have been modified in some way prior to being input to the modifier 30. In this example, the to-be-modified signal comprises the first input signal I₁.

In examples, the modifier 30 modifies the to-be-modified signal using (or “based on”) another signal. The other signal may be referred to herein as a “modification signal”, a “modifying signal” or the like. In this example, the modification signal comprises the second input signal I₂. The modifier 30 outputs a modified signal I_{M}.

A modifier may be a combining modifier, which modifies the to-be-modified signal by combining the to-be-modified signal with the modification signal. Such combining may take various different forms, examples of which are described below.

A modifier may be an additive modifier, which modifies the to-be-modified signal by adding the modification signal to the to-be-modified signal. Such addition may involve the modifier adding a signal element value of a signal element of the modification signal to a signal element value of a corresponding signal element of the to-be-modified signal. The result of such addition may be a signal element value of a corresponding signal element of the modified signal.

A modifier may be a subtractive modifier, which modifies the to-be-modified signal by subtracting the modification signal from the to-be-modified signal (or vice versa). Such subtraction may involve the modifier subtracting a signal element value of a signal element of the modification signal from a signal element value of a corresponding signal element of the to-be-modified signal. The result of such subtraction may be a signal element value of a corresponding signal element of the modified signal.

A modifier may be a substitutive (or “substitution”, “replacing”, “replacement”, “overwriting” or the like) modifier, which modifies the to-be-modified signal by substituting one or more values of the to-be-modified signal with one or more corresponding values from the modification signal. Such substitution may involve the modifier replacing a signal element value of a signal element of the to-be-modified signal with a signal element value of a corresponding signal element of the modification signal. The result of such substitution may be signal element value of a corresponding signal element of the modified signal.

A modifier may be a shifting (or “shift”) modifier, which modifies the to-be-modified signal by shifting the position of one or more values of the to-be-modified signal within the to-be-modified signal. For example, the modification signal may indicate that all values of the to-be-modified signal are to be shifted one signal element to the right. In such an example, the value “one” from the modification signal is not added to or subtracted from, and does not replace, any signal element values of the to-be-modified signal, but nevertheless influences how the to-be-modified signal is modified.

Other types of modifier may be used.

As such, in examples, the modified signal has an element (e.g., a signal element) corresponding to an element (e.g., a signal element) of the to-be-modified signal. The element (e.g., a signal element) of the modified signal has a modified value with respect to a value of the corresponding element (e.g., a signal element) of the to-be-modified signal. As such, the modified value is different from the value of the corresponding element of the to-be-modified signal. The modified value may have been modified as a result of addition, subtraction, substitution, shifting or any other modifying operation.

The modified input signal I_{M} is provided to a down-sampler 105D. The down-sampler 105D outputs, at the base level, a down-sampled signal B derived based on down-sampling the modified input signal I_{M}. The down-sampled signal B may be considered to be a down-sampled modified signal, since it is a down-sampled version of the modified input signal I_{M}. The down-sampler 105D outputs (or “sends”) to an encoder, which in this example is a base encoder 120E at the base level of the encoder 100. The down-sampler 105D also outputs to a residual generator 110-S. An encoded base stream B_{E} is created directly by the base encoder 120E, and may be quantised and entropy encoded as necessary according to the base encoding scheme. The encoded base stream B_{E} may be referred to as the base layer or base level. The encoded base stream B_{E} may be considered to be an encoded modified signal, since it is an encoded version of the down-sampled signal B, which itself is a down-sampled version of the modified input signal I_{M}.

To generate an encoded sub-layer 1 enhancement stream, the encoded base stream B_{E} is received from the encoder, which in this example is the base encoder 120E. The encoded base stream B_{E} is decoded via a decoding operation that is applied at a base decoder 120D. The decoding generates a decoded base stream B_{D}. In preferred examples, the base decoder 120D may be a decoding component that complements an encoding component in the form of the base encoder 120E within a base codec. In other examples, the base decoding block 120D may instead be part of the enhancement level.

The decoded base stream B_{D} is then processed to generate a processed signal. In this example, the processed signal is an up-sampled signal U, which will be described in more detail below.

Via the residual generator 110-S, a difference between the decoded base stream B_{D} output from the base decoder 120D and the down-sampled input video B is created (i.e., a subtraction operation 110-S is applied to a frame of the down-sampled input video B and a frame of the decoded base stream B_{D} to generate a set of residuals). As such, the residual generator 110-S uses and processes both the decoded base stream B_{D} and the down-sampled input video B to generate the set of residuals. Here, residuals represent the error or differences between a reference signal or frame and a desired signal or frame. The residuals used in the first enhancement level can be considered as a correction signal as they are able to ‘correct’ a frame of a (future) decoded base stream. To distinguish from the residuals used in the second enhancement level, the residuals used in the first enhancement level will be referred to hereafter as “correction data”. The correction data is useful as it can correct for quirks or other peculiarities of the base codec. These include, amongst others, motion compensation algorithms applied by the base codec, quantisation and entropy encoding applied by the base codec, and block adjustments applied by the base codec.

In FIG. 1, the set of correction data is used and processed by being transformed, quantized and entropy encoded to produce the encoded sub-layer 1 stream. In FIG. 1, a transform operation 110-1 is applied to the set of correction data; a quantization operation 120-1 is applied to the transformed set of correction data to generate a set of quantized correction data; and an entropy encoding operation 130-1 is applied to the quantized set of correction data to generate the encoded sub-layer 1 stream at the first level of enhancement. However, it should be noted that in other examples only the quantisation step 120-1 may be performed, or only the transform step 110-1. Entropy encoding may not be used, or may optionally be used in addition to one or both of the transform step 110-1 and quantisation step 120-1. The entropy encoding operation can be any suitable type of entropy encoding, such as a Huffmann encoding operation or a run-length encoding (RLE) operation, or a combination of both a Huffmann encoding operation and a RLE operation (e.g., RLE then Huffmann or prefix encoding).

To generate the encoded sub-layer 2 stream, a further level of enhancement information is created by producing and encoding a further set of residuals via residual generator 100-S.

The up-sampler 105U up-samples a corrected (via the below-described sub-layer 1 correction) version of the decoded base stream B_{D} to produce an up-sampled version U (via up-sampler 105U) of a corrected version of the decoded base stream B_{D}. The up-sampled version U may be referred to as a reference signal, a reference frame, or the like. In this example, the up-sampled version U is the processed signal referred to above.

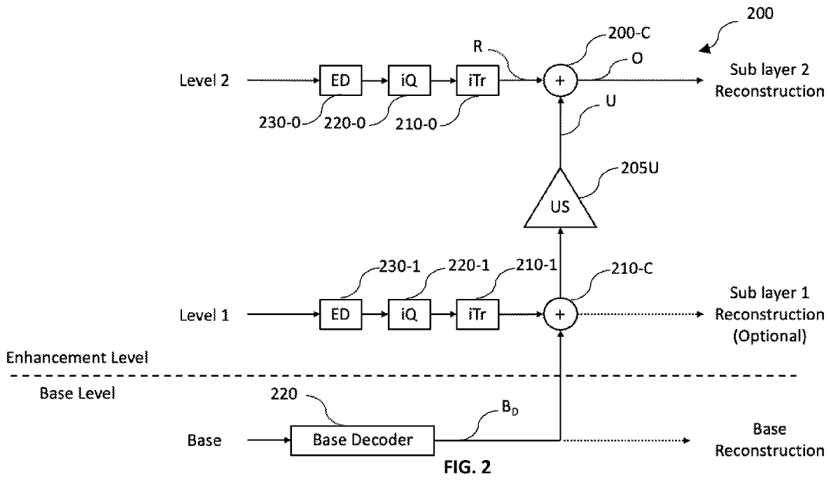

To achieve a reconstruction of the corrected version of the decoded base stream as would be generated at a decoder (e.g., as shown in FIG. 2), at least some of the sub-layer 1 encoding operations are reversed to mimic the processes of the decoder, and to account for at least some losses and quirks of the transform and quantisation processes. To this end, the set of correction data is processed by a decoding pipeline comprising an inverse quantisation block 120-1i and an inverse transform block 110-1i. The quantized set of correction data is inversely quantized at inverse quantisation block 120-1i and is inversely transformed at inverse transform block 110-1i in the encoder 100 to regenerate a decoder-side version of the set of correction data. The decoded base stream B_{D} from decoder 120D is then combined with the decoder-side version of the set of correction data (i.e., a summing operation 110-C is performed on the decoded base stream B_{D} and the decoder-side version of the set of correction data). Summing operation 110-C generates a reconstruction of the down-sampled version of the modified input video I_{M} as would be generated in all likelihood at the decoder—i.e., a reconstructed base codec video. The reconstructed base codec video is then up-sampled by up-sampler 105U to generate an up-sampled signal U. Processing in this example is typically performed on a frame-by-frame basis.

The residual generator 100-S generates a further set of residuals R based at least on a value of an element of a target signal and a value of a corresponding element of the processed signal. The target signal may also be referred to as a target frame, a desired signal, a desired frame or the like. In this example, the target signal is the first input signal I₁, which is also the to-be-modified signal in this example. As explained above, in this example the processed signal comprises the up-sampled signal U.

As such, in this example, the further set of residuals R are the difference between the up-sampled version U (via up-sampler 105U) of the corrected version of the decoded base stream B_{D} (the processed signal), and the first input signal I₁ (the target signal).

In more detail, the up-sampled signal U (i.e., reference signal or frame) is compared to the first input signal I₁ (i.e., desired signal or frame) to create the further set of residuals R (i.e., a difference operation is applied by the residual generator 100-S to the up-sampled re-created frame U to generate the further set of residuals R). The further set of residuals R is then processed via an encoding pipeline that mirrors that used for the set of correction data to become an encoded sub-layer 2 stream (i.e., an encoding operation is then applied to the further set of residuals R to generate the encoded further enhancement stream). In particular, the further set of residuals R are transformed (i.e., a transform operation 110-0 is performed on the further set of residuals R to generate a further transformed set of residuals). The transformed residuals are then quantized and entropy encoded in the manner described above in relation to the set of correction data (i.e., a quantization operation 120-0 is applied to the transformed set of residuals to generate a further set of quantized residuals; and an entropy encoding operation 120-0 is applied to the quantized further set of residuals to generate the encoded sub-layer 2 stream containing the further level of enhancement information). In certain cases, the operations may be controlled, e.g., such that, only the quantisation step 120-1 may be performed, or only the transform and quantization step. Entropy encoding may optionally be used in addition. Preferably, the entropy encoding operation may be a Huffmann encoding operation or a run-length encoding (RLE) operation, or both (e.g., RLE then Huffmann encoding). The transformation applied at both blocks 110-1 and 110-0 may be a Hadamard transformation that is applied to 2×2 or 4×4 blocks of residuals. In this example, the encoder used to encode the further set of residuals R (or the data derived based on the further set of residuals R) is different from the base encoder 120E used to encode the base stream.

The encoding operation in FIG. 1 does not result in dependencies between local blocks of the input signal (e.g., in comparison with many known coding schemes that apply inter or intra prediction to macroblocks and thus introduce macroblock dependencies). Hence, the operations shown in FIG. 1 may be performed in parallel on 4×4 or 2×2 blocks, which greatly increases encoding efficiency on multicore central processing units (CPUs) or graphical processing units (GPUs).

As illustrated in FIG. 1, the output of the spatially scalable encoding process is one or more enhancement streams at an enhancement level which preferably comprises a first level of enhancement and a further level of enhancement. This is then combinable (e.g., via multiplexing or otherwise) with a base stream at a base level. The first level of enhancement (sub-layer 1) may be considered to enable a corrected video at a base level, that is, for example to correct for encoder quirks. The second level of enhancement (sub layer 2) may be considered to be a further level of enhancement that is usable to convert the corrected video to the original input video or a close approximation thereto. For example, the second level of enhancement may add fine detail that is lost during the down-sampling and/or help correct from errors that are introduced by one or more of the transform operation 110-1 and the quantization operation 120-1.

FIG. 2 shows a corresponding example decoder 200 for the example spatially scalable coding scheme. The encoded base stream is decoded at base decoder 220 in order to produce a base reconstruction of the modified input signal I_{M}. It should be understood that, without the second input signal I₂ and the modifier 30, decoding the encoded base stream would produce a base reconstruction of the first input signal I₁ and not the modified input signal I_{M}. The base reconstruction of the modified input signal I_{M} may be used in practice to provide a viewable rendition of the modified input signal I_{M} at the lower quality level. It should, again, be understood that the viewable rendition at the lower quality level is of the modified input signal I_{M} (with the visual artefact(s)) and not of the first input signal I₁. The primary purpose of the base reconstruction signal, i.e., the base reconstruction of the modified input signal I_{M}, is to provide a base for a higher quality rendition of the modified input signal I_{M} and, as will become more apparent below, ultimately, the first input signal I₁. To this end, the decoded base stream is provided for sub-layer 1 processing (i.e., sub-layer 1 decoding). Sub-layer 1 processing in FIG. 2 comprises an entropy decoding process 230-1, an inverse quantization process 220-1, and an inverse transform process 210-1. Optionally, only one or more of these steps may be performed depending on the operations carried out at corresponding block 100-1 at the encoder. By performing these corresponding steps, a decoded sub-layer 1 stream comprising the set of correction data is made available at the decoder 200. The set of correction data is combined with the decoded base stream from base decoder 220 (i.e., a summing operation 210-C is performed on a frame of the decoded base stream B_{D} and a frame of the decoded set of correction data to generate a reconstruction of the down-sampled version of the modified input video B—i.e., the reconstructed base codec video). A frame of the reconstructed base codec video is then up-sampled by up-sampler 205U.

Additionally, and optionally in parallel, the encoded sub-layer 2 stream is processed to produce a decoded further set of residuals R. Similar to sub-layer 1 processing, sub-layer 2 processing comprises an entropy decoding process 230-0, an inverse quantization process 220-0 and an inverse transform process 210-0. Of course, these operations will correspond to those performed at block 100-0 in encoder 100, and one or more of these steps may be omitted as necessary. Block 200-0 produces a decoded sub-layer 2 stream comprising the further set of residuals R and these are summed at operation 200-C with the output U from the up-sampler 205U in order to create a sub-layer 2 reconstruction of the input signal I₁, which may be provided as the output O of the decoder. Thus, as illustrated in FIGS. 1 and 2, the output of the decoding process may comprise up to three outputs: a base reconstruction, a corrected lower resolution signal and an original signal reconstruction O at a higher resolution.

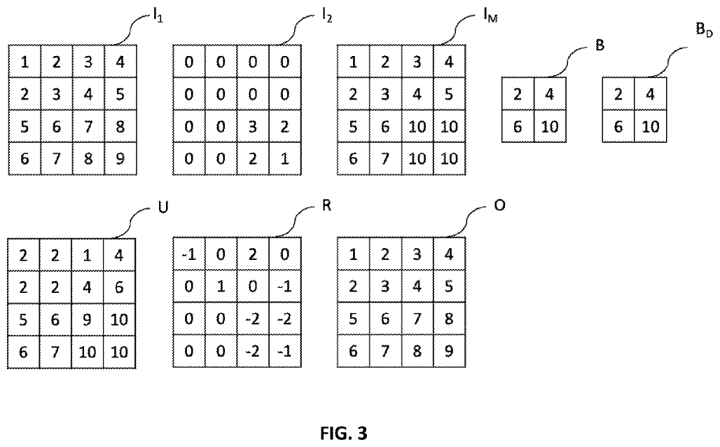

FIG. 3 shows example signal element values of example signals that may be processed in the example systems shown in FIGS. 1 and 2.

The numerical signal element values used in this and other examples should be understood to be by way of example only.

As explained above, first and second input signals I₁, I₂ are received. In this example, the combiner 30 is an additive combiner, which adds the first and second input signals I₁, I₂ together to generate the modified input signal I_{M}. In this example, such adding involves adding a signal element value of a signal element in the first input signal I₁ and a signal element value of a corresponding signal element in the second input signal I₂ together to create a signal element value of a corresponding signal element in the modified input signal I_{M}. In this example, corresponding signal elements have the same position as each other within their respective signals.

The down-sampler 105D receives and down-samples the modified input signal I_{M} to generate the down-sampled input signal B. In this example, such down-sampling involves averaging the signal element values of each signal element in a 2×2 block of signal elements in the modified input signal I_{M}, to give a signal element value of a corresponding signal element in the down-sampled input signal B. However, down-sampling can be performed in other ways. In this example, a signal element in the down-sampled input signal B corresponds to a 2×2 block of signal elements in the modified input signal I_{M}.

In this and other examples, for convenience and brevity, it is assumed that the decoded base stream B_{D} is the same as the down-sampled input signal B. In other words, it is assumed that the down-sampled input signal B is encoded by the base encoder 102E to generate the encoded base stream B_{E}, the encoded base stream B_{E} is decoded by the base decoder 120D to generate the decoded base stream B_{D}, and the signal element values of signal elements of the decoded base stream B_{D} are the same as the signal element values of corresponding signal elements of the down-sampled input signal B. However, the original signal reconstruction O at the higher resolution can still be achieved in a similar manner even if the decoded base stream B_{D} is not the same as the down-sampled input signal B. In particular, the above-described set of correction data can remove encode-decode errors.

In this and other examples, for convenience and brevity, it is also assumed that no errors are introduced in the sub-layer 1 processing. In other words, it is assumed that the output of the residual generator 110-S is the same is the input to the summing operation 110-C from the inverse transform block 110-1i. Again, the original signal reconstruction O at the higher resolution can still be achieved in a similar manner even if errors are introduced in the sub-layer 1 processing.

The up-sampler 105U up-samples the decoded base stream B_{D} (whether or not the decoded base stream B_{D} has been subject to correction) to generate the up-sampled signal U.

In this example, the signal element values of signal elements of the up-sampled signal U are not exactly the same as signal element values of corresponding signal elements of the first input signal I₁. This may be as a result of asymmetries between the down-sampling and the up-sampling.

The residual generator 100-S calculates a difference between a target signal, which in this example is the first input signal I₁, and a processed signal, which in this example is the up-sampled signal U. In this example, such calculation involves subtracting a signal element value of a signal element in the up-sampled signal U from a signal element value of a corresponding signal element in the first input signal I₁ to give a value of a corresponding residual element in the further set of residuals R.

As explained above, in terms of decoder-side processing, a decoder can generate the up-sampled signal U using the encoded base stream B_{E} and the set of correction data. Combining the up-sampled signal U with the further set of residuals R creates the original signal reconstruction O at the higher resolution. In this example, such combining involves adding a signal element value of a signal element in the up-sampled signal U and a signal element value of a corresponding residual element in the further set of residuals R together to give a signal element value of a corresponding signal element in the original signal reconstruction O.

It should be understood that, although the effect of the modification is visible in the base video stream, i.e., in the decoded base stream B_{D}, and the up-sampled signal U, it is not visible in the original signal reconstruction O.

As such, if a decoder receives the encoded base stream B_{E}, it will be able to recover some content of the first input signal I₁ at the base level. The decoder may also be able to up-sample the decoded base stream B_{D} and recover some content of the first input signal I₁ at a higher spatial resolution. However, without the further set of residual data R, the decoder would not be able to reconstruct fully the first input signal I₁.

The absolute values of the residuals in the bottom-right 2×2 block in the first set of residuals R are generally larger than those in the other 2×2 blocks in the first set of residuals R. This is, in this example, primary as a result of the modification modifying the values of the signal elements in the corresponding 2×2 block of the first input signal I₁, such that the first input signal I₁ and the up-sampled signal U are particularly different in that 2×2 block in the first set of residuals R.

Since the residuals in the bottom-right 2×2 block in the first set of residuals R are likely to have a more significant impact on the visual quality of the original signal reconstruction O than the residuals in the other 2×2 blocks in the first set of residuals R, they may be processed differently from the other residuals in the first set of residuals R. For example, the residuals in the bottom-right 2×2 block (corresponding to the modified signal elements of the first input signal I₁) may not be subject to any quantization, or at least may be subject to a lower level of quantization than other residuals in the first set of residuals R.

It should also be understood that in many spatially scalable coding schemes and systems, it would be desirable to minimise the values of all residuals in the first set of residuals R. This can make encoding such residuals more efficient and can reduce the amount of residual data to be processed.

In contrast, the modification described above goes against such general desires by increasing the size of the values of some of the residuals in the first set of residuals R, compared to the size those values would have been without such modification. A benefit of such modification is, as described above, improved content protection.

In this example, the first, second and modified input signals I₁, I₂, I_{M} are shown as being 4×4 arrays. In practice, the signals may have much larger dimensions.

Additionally, in this example, the modification occurs in the bottom-right 2×2 block of the array. Where signals may have much larger dimensions, modifications may occur at more central and visually prominent parts of the signal to maximise the (negative) effect of the modification on a viewer of the base layer stream without the enhancement.

In this example, the values of the elements in the bottom-right 2×2 block of the second input signal I₂ are selected, based on the values of the corresponding elements of the bottom-right 2×2 block of the first input signal I₁, such that the values of the elements in the bottom-right 2×2 block of the modified input signal I_{M} are all ‘10’. Assuming, for this example only, that ‘10’ is the maximum signal element value, the values of the elements in the bottom-right 2×2 block of the second input signal I₂ may be selected independently of the values of the corresponding elements of the bottom-right 2×2 block of the first input signal I₁; for example, they may all be set to ‘10’. If the first and second input signals I₁, I₂ are added together and if the sum of values of corresponding signal elements exceeds 10, the value of the corresponding signal element for the modified input signal I_{M+} can be set to the maximum value of ‘10’.

FIG. 4 shows a system configuration for another example spatially scalable encoder 100.

The example spatially scalable encoder 100 shown in FIG. 4 is similar to the example spatially scalable encoder 100 shown in FIG. 1.

However, in the example spatially scalable encoder 100 shown in FIG. 1, the modifier 30 is in the enhancement level and the second input signal I₂ is an enhancement-level signal. The modifier 30 modifies the first input signal I₁ using the second input signal I₂ in the enhancement level to generate the modified input signal I_{M} in the enhancement level, and the modified input signal I_{M} is then down-sampled to generate a down-sampled (modified) signal B.

In contrast, in the example spatially scalable encoder 100 shown in FIG. 4, the modifier 30 is in the base level and the second input signal I₁₂ is a base-level signal. The first input signal I₁ is down-sampled to generate the down-sampled signal B, and the modifier 30 modifies the down-sampled signal B in the base level using the second input signal I₂ to generate a modified down-sampled signal B_{M}.

Further, in this example, the target signal, based on which the residual generator 100-S generates the set of residual data R, comprises a to-be-down-sampled signal. In this example, the to-be-down-sampled signal is the first input signal I₁. The to-be-down-sampled signal, namely the first input signal I₁, is down-sampled to derive the to-be-modified signal, namely the down-sampled signal B.

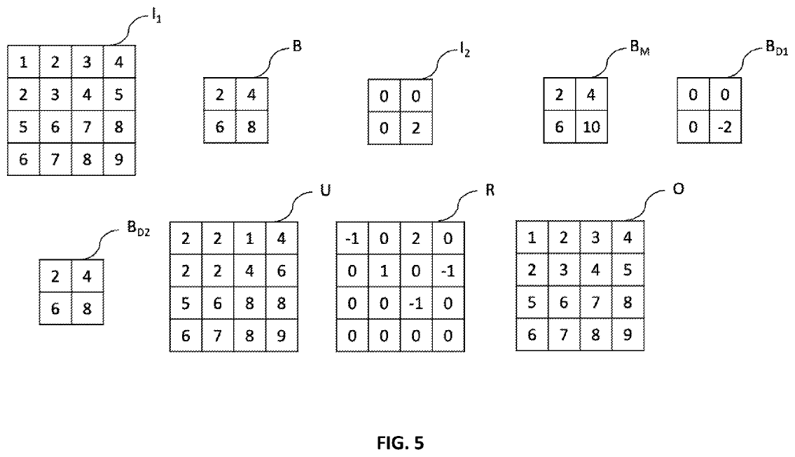

FIG. 5 shows example signal element values of example signals that may be processed in the example system shown in FIG. 4 and a corresponding decoder.

As explained above, a first input signal I₁ is down-sampled to create a down-sampled signal B, for example by averaging.

In this example, the combiner 30 is an additive combiner, which adds the down-sampled signal B and the second input signal I₂ together to generate a modified down-sampled signal B_{M}. The base encoder 120E encodes the modified down-sampled signal B_{M} to generate an encoded base stream B_{E} and the base decoder 120D decodes the encoded base stream B_{E} to generate a decoded base stream B_{D}. In this specific example, for convenience and brevity, it is again assumed that the decoded base stream B_{D} is the same as the modified down-sampled signal B_{M}, which may be expressed mathematically as: B_{D}=B_{M}.

The output B_{D1} of the residual generator 110-S is the difference between the down-sampled signal B and the decoded down-sampled signal B_{D}, which may be expressed mathematically as: B_{D1}=B−B_{D}=B−B_{M}. In this example, the modified down-sampled signal B_{M} is the combination of the down-sampled signal B and the second input signal I₂, which may be expressed mathematically as: B_{M}=B+I₂. Taking these two mathematical expressions together, B_{D1}=B−B_{M}=B−(B+I₂)=−I₂.

The output B_{D2} of the summing operation 110-C is the sum of the decoded base stream B_{D} (which equals the modified down-sampled signal B_{M}) and the output B_{D1} of the residual generator 110-S, which may be expressed mathematically as: B_{D2}=B_{M}+B_{D1}. However, from above, B_{D1}=B−B_{M}. As such, B_{D2}=B_{M}+B_{D1}=B_{M}+(B−B_{M})=B. As such, the modification caused by the second input signal I₂ has, in effect, been removed at the output B_{D2} of the summing operation 110-C.

The output B_{D2} of the summing operation 110-C is then up-sampled to generate the up-sampled signal U, and the further set of residuals R is calculated based on differences between the first input signal I₁ and the up-sampled signal U.

Again, in terms of decoder-side processing, a decoder can generate the up-sampled signal U using the encoded base stream B_{E} and the set of correction data. Combining the up-sampled signal U with the further set of residuals R creates the original signal reconstruction O at the higher resolution. Additionally, although, again, the effect of the modification is visible in the base video stream, i.e., in the decoded base stream B_{M}, it is not visible in the original signal reconstruction O. The absolute values of the residuals in the bottom-right 2×2 block in the first set of residuals R shown in FIG. 4 are smaller than those in the bottom-right 2×2 block in the first set of residuals R shown in FIG. 1. This is because, in effect, the modification has been undone before the up-sampled signal U is subtracted from the first input signal I₁. The up-sampled signal U is therefore likely to be more similar to the first input signal I₁, and the absolute values of the residuals in the first set of residuals R are therefore likely to be smaller. This may result in more efficient residual encoding, as explained above.

FIG. 6 shows a system configuration for another example spatially scalable encoder 100.

The example spatially scalable encoder 100 shown in FIG. 6 is similar to the example spatially scalable encoder 100 shown in FIG. 1.

However, in the example spatially scalable encoder 100 shown in FIG. 1, the residual generator 100-S calculates the difference between the first input signal I₁ and the up-sampled signal U.

In contrast, in the example spatially scalable encoder 100 shown in FIG. 6, the residual generator 100-S calculates the difference between the modified input signal I_{M} (the target signal) and the up-sampled signal U. This creates a first further set of residuals R₁.

Additionally, the example spatially scalable encoder 100 shown in FIG. 6 comprises a further modifier 40, which modifies the output of the residual generator 100-S using a third input signal I₃. In this example, the third input signal I₃ is the negative (or “inverse”) of the second input signal I₂, which may be written mathematically as: I₃=−I₂. This creates a second further set of residuals R₂.

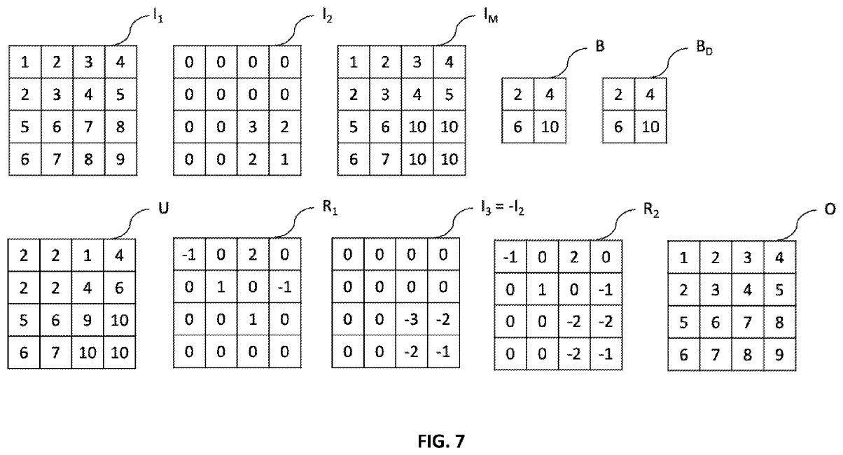

FIG. 7 shows example signal element values of example signals that may be processed in the example system shown in FIG. 6 and a corresponding decoder.

The first further set of residuals R₁ is calculated as the difference between the modified input signal I_{M} and the up-sampled signal U. As such, in this example, the target signal, based on which the first further set of residuals R₁ is generated, comprises the modified input signal I_{M}.

The second further set of residuals R₂ is calculated as the sum of the first further set of residuals R₁ and the third input signal I₃. As such, further residual data (namely, the second further set of residuals R₂) is generated based on a value of an element of the first further set of residuals R₁ and a value of a corresponding element of a signal based on the modification signal I₂. In this example, the signal based on the modification signal I₂ is obtained by processing the modification signal I₂. In this example, such processing involves calculating the negative (or “inverse”) of the modification signal I₂ to generate the third input signal I₃.

It should be noted that the second set of residuals R₂ shown in FIG. 7 corresponds to the set of residuals R shown in FIG. 3, despite the different configurations of the example spatially scalable encoders 100 shown in FIGS. 1 and 6 respectively.

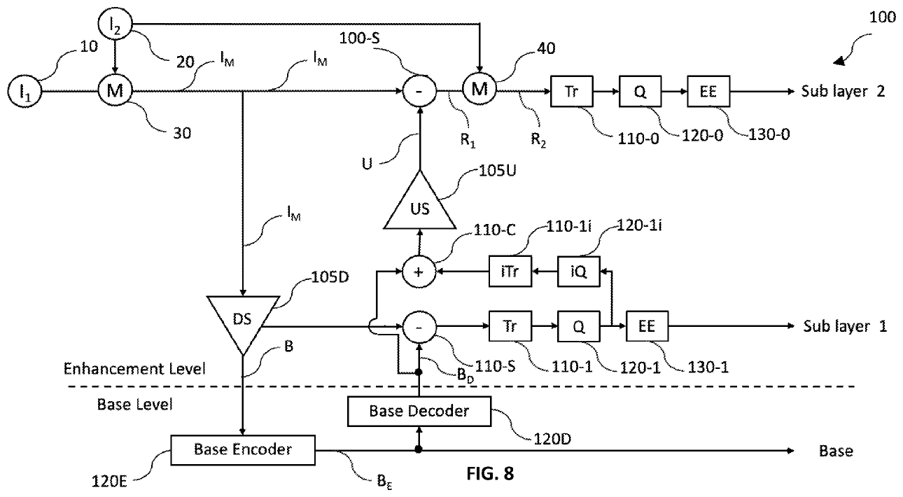

FIG. 8 shows a system configuration for another example spatially scalable encoder 100.

The example spatially scalable encoder 100 shown in FIG. 8 is similar to the example spatially scalable encoder 100 shown in FIG. 6.

However, in the example spatially scalable encoder 100 shown in FIG. 6, the further modifier 40 adds the third input signal I₃, namely the negative of the second input signal −I₂, to the first further set of residuals R₁ to generate the second further set of residuals R2. This may be expressed mathematically as: R₂=I₃+R₁=(−I₂)+R₁=R₁−I₂.

In contrast, in the example spatially scalable encoder 100 shown in FIG. 8, the further modifier 40 subtracts the second input signal I₂ from the first further set of residuals R1 to generate the second further set of residuals R₂. This may be expressed mathematically as: R₂=R₁−(I₂)=R₁−I₂.

As such, in this example, the second further set of residuals R₂ is calculated as the difference between the first further set of residuals R₁ and the modification signal I₂. As such, further residual data is generated based on a value of an element of the first further set of residuals R₁ and a value of a corresponding element of the modification signal I₂.

It can therefore be seen that the example spatially scalable encoders 100 shown in FIGS. 6 and 8 produce the same encoded base stream B_{E}, sets of correction data, and first and second further sets of residuals R₁, R₂ as each other.

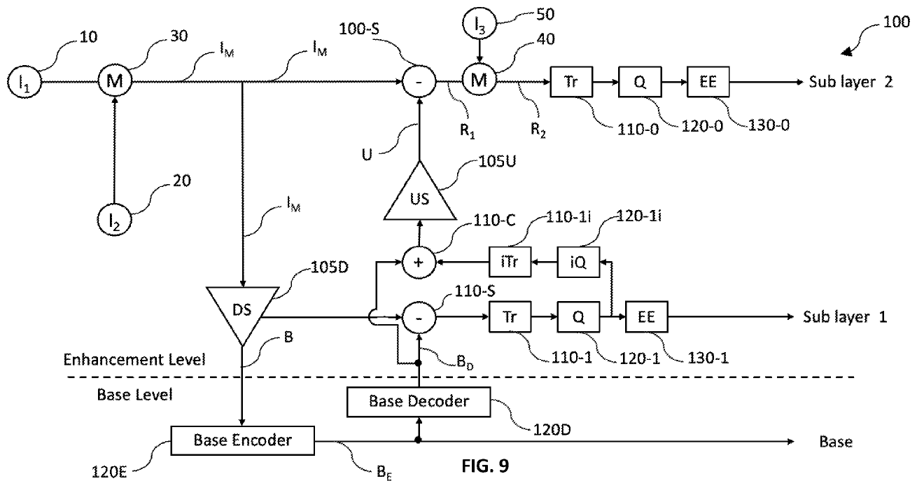

FIG. 9 shows a system configuration for another example spatially scalable encoder 100.

The example spatially scalable encoder 100 shown in FIG. 9 is similar to the example spatially scalable encoder 100 shown in FIG. 6.

However, in the example spatially scalable encoder 100 shown in FIG. 6, the modifiers 30, 40 are additive modifiers. In particular, the first and second input signals I₁, I₂ are added together, and the first set of residuals R₁ is added to the third input signal I₃, which is the negative of the second input signal −I₂.

In contrast, in the example spatially scalable encoder 100 shown in FIG. 9, the modifiers 30, 40 are substitutive modifiers.

In particular, the modifier 30 substitutes (which may also be referred to as “replaces” or “overwrites”) a signal element value of a signal element in the first input signal I₁ with a signal element value of a corresponding signal element in the second input signal I₂ to give a signal element value of a corresponding signal element in the modified input signal I_{M}.

In this example, not all signal element values of signal elements in the first input signal I₁ are overwritten. However, in this example, signal element values of signal elements in the first input signal I₁ that are overwritten form the basis of the third input signal I₃. As such, in this example, the first input signal I₁ is processed to derive the third input signal I₃.

Additionally, the further modifier 40 overwrites any values of residual elements in the first set of residuals R₁ corresponding to a modified signal element of the modified input signal I_{M} with the signal element values of the corresponding signal element of the third input signal I₃.

Again, in this example, not all values of all residual elements in the first set of residuals R₁ are overwritten by the further modifier 40; only those residual elements corresponding to a modified signal element of the modified input signal I_{M}.

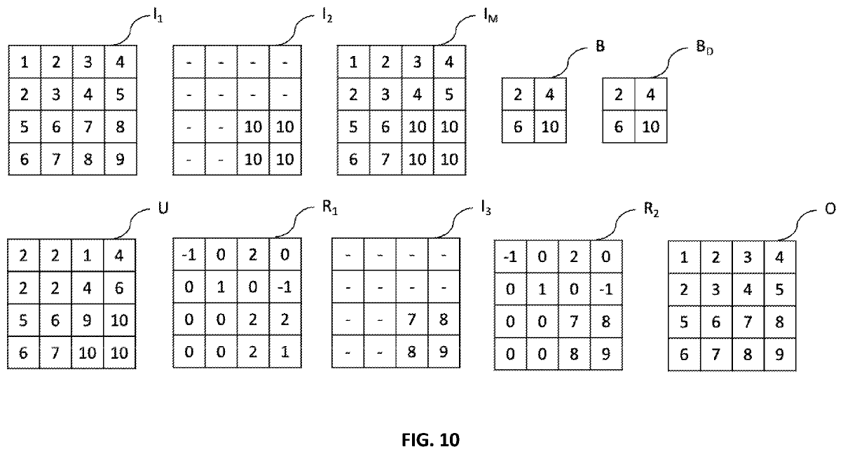

FIG. 10 shows example signal element values of various example signals that may be processed in the example system shown in FIG. 9.

In this example, the modifier 30 overwrites the signal element values “7”, “8”, “8” and “9” in the bottom-right 2×2 block of the first input signal I₁ with the signal element values “10”, “10”, “10” and “10” in the bottom-right 2×2 block of the second input signal I₂. The modifier 40 overwrites the residual values “2”, “2”, “2” and “1” in the bottom-right 2×2 block of the first set of residuals R₁ with the signal element values “7”, “8”, “8” and “9” in the bottom-right 2×2 block of the third input signal I₃.

Instead of the third input signal I₃ storing the signal element values “7”, “8”, “8” and “9” from the first input signal I₁, the third input signal I₃ could indicate which residuals in the first set of residual elements R₁ are to be overwritten with corresponding signal element values from the first input signal I₁.

FIG. 11 shows a system configuration for another example spatially scalable encoder 100.

The example spatially scalable encoder 100 shown in FIG. 11 is similar to the example spatially scalable encoder 100 shown in FIG. 1.

However, in the example spatially scalable encoder 100 shown in FIG. 1, the residual generator 110-S outputs to the transform operation 110-1.

In contrast, in the example spatially scalable encoder 100 shown in FIG. 11, the residual generator 110-S outputs to a further modifier 40. The further modifier 40 receives a third input signal I₃ as an input 50. The further modifier 40 modifies the output of the residual generator 110-S using the third input signal I₃ and outputs the result to the transform operation 110-1.

As such, in this example, correction data is generated based on: (i) a value of an element of the down-sampled modified signal B, (ii) a value of a corresponding element of the decoded modified signal B_{D}, and (iii) a value of a corresponding element of the modification signal I₂ or a value of a corresponding element of a signal I₃ based on the modification signal. In this specific example, the signal based on the modification signal, namely the third input signal I₃, is used but, in other examples, the modification signal I₂ may be used.

In this example, the signal based on the modification signal, namely the third input signal I₃, is derived by processing the modification signal I₂. In this specific example, such processing involves down-sampling the modification signal I₂ and creating a negative of the down-sampled modification signal, as will become more apparent below.

The correction data, or data derived based on the correction data, can be sent to be encoded.

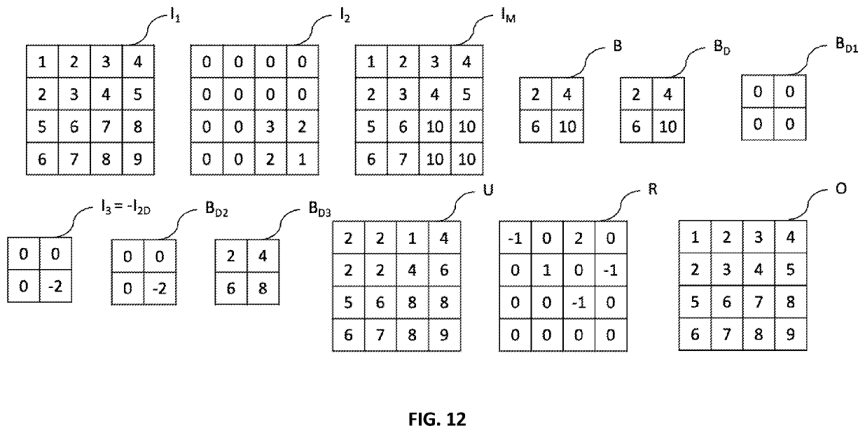

FIG. 12 shows example signal element values of example signals that may be processed in the example system shown in FIG. 11 and a corresponding decoder.

In this example, the combiner 30 is an additive combiner, which adds the first and second input signals I₁, I₂ together to generate the modified input signal I_{M}, and the down-sampler 105D down-samples the modified input signal I_{M} to generate the down-sampled signal B. The base encoder 120E encodes the down-sampled signal B to generate an encoded base stream B_{E} and the base decoder 120D decodes the encoded base stream B_{E} to generate a decoded base stream B_{D}. In this specific example, for convenience and brevity, it is again assumed that the decoded base stream B_{D} is the same as the down-sampled signal B, which may be expressed mathematically as: B_{D}=B.

The output B_{D1} of the residual generator 110-S is the difference between the down-sampled signal B and the decoded down-sampled signal B_{D}, which may be expressed mathematically as: B_{D1}=B−B_{D}. Since, in this example, B_{D}=B, it follows that B_{D1}=0.

In this example, the third input signal I₃ is the negative of a down-sampled version of the second input signal −I_{2D}. The third input signal I₃ may be obtained by down-sampling the second input signal I₂ and generating a negative of the result.

In this example, the modifier 40 modifies the output B_{D1} of the residual generator 110-S by adding the third input signal I₃ to give an output B_{D2}, where: B_{D2}=B_{D1}+(−I_{2D})=0+(−I_{2D})=−I_{2D}.

The output B_{D3} of the summing operation 110-C is the sum of the decoded base signal B_{D} and the output B_{D2} of the modifier 40, which may be expressed mathematically as: B_{D3}=B_{D}+B_{D2}. However, since B_{D} is generated by down-sampling I_{M}, where I_{M}=I₁+I₂, the summing operation 110-C effectively cancels out the down-sampled I₂, leaving the output B_{D3} of the summing operation 110-C as the down-sampled I₁.

The output B_{D3} of the summing operation 110-C, namely the down-sampled I₁, is then up-sampled to generate the up-sampled signal U, and the further set of residuals R is calculated based on differences between the first input signal I₁ and the up-sampled signal U.

Again, in terms of decoder-side processing, a decoder can generate the up-sampled signal U using the encoded base stream B_{E} and the set of correction data. Combining the up-sampled signal U with the further set of residuals R creates the original signal reconstruction O at the higher resolution. Additionally, although, again, the effect of the modification is visible in the base video stream, i.e., in the decoded base stream B_{D}, it is not visible in the original signal reconstruction O.

The set of residuals R in FIG. 12 have smaller absolute values than the set of residuals R in FIG. 3, as can be seen by comparing the bottom-right 2×2 blocks. The set of residuals R in FIG. 12 may therefore be more efficient to encode than those shown in FIG. 3.

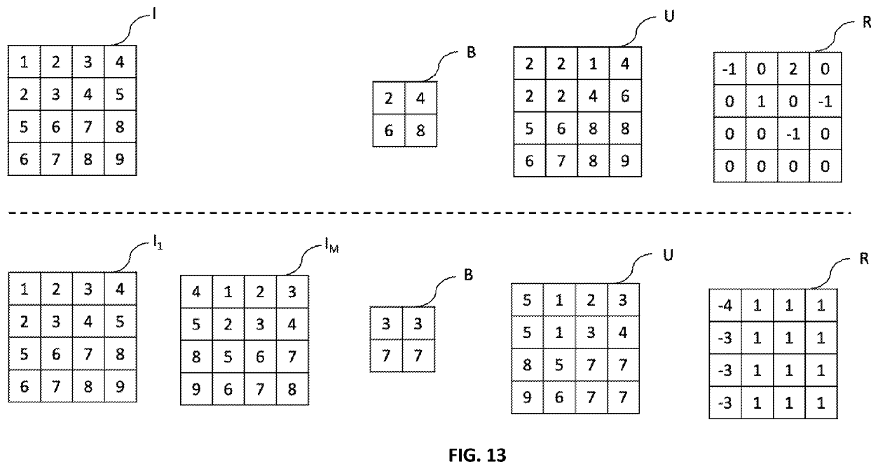

FIG. 13 shows example signal element values of example signals that may be processed in an example signal encoding and decoding system.

The top part of FIG. 13 above the dashed line shows how an example input signal I that is not subject to modification can be down-sampled to generate a down-sampled signal B, the down-sampled signal B can be up-sampled to create an up-sampled signal U, and a set of further residuals R can be generated based on the difference between the input signal I and the up-sampled signal U.

The bottom part of FIG. 13 below the dashed line shows how an example first input signal I₁ (which is the same as the input signal I in the top part of FIG. 13) can be modified using a shifting modifier to generate a modified input signal I_{M}. In this example, the shifting modifier modifies the first input signal I₁ by shifting, in each row, each value in the first input signal I₁ one signal element to the right. In each row, the final value becomes the new first value. For example, in the first row, the value of the first signal element of the first input signal I₁ becomes the value of the second signal element of the modified input signal I_{M}, the value of the fourth signal element of the first input signal I₁ becomes the value of the first signal element of the modified input signal I_{M}, and so on.

Even if a decoder were to receive an encoded version of the base video stream B in the bottom part of FIG. 13 and were able to use a decoded version of the base video stream B in the bottom part of FIG. 13 to generate the up-sampled signal U in the bottom part of FIG. 13, they would still need the first set of residuals R in the bottom part of FIG. 13 to recover the first input signal I₁ in the bottom part of FIG. 13. Applying the first set of residuals R in the top part of FIG. 13 to the up-sampled signal U in the bottom part of FIG. 13 would not recover the first input signal I₁ in the bottom part of FIG. 13. Additionally, the base video stream B and up-sampled signal U in the bottom part of FIG. 13 are not particularly accurate renditions of the first input signal I₁ and contain visual artefacts as a result of the shifting modification.

As such, a shifting modifier can likewise provide content protection.

The shifting modifier may apply different-sized and/or different-direction shifts to different encodings. This can provide a further degree of content protection.

In more detail, a first encoding of the first input signal I₁ may use a first shift (in terms of size and/or direction) and a second encoding of the first input signal I₁ may use a second, different shift (in terms of size and/or direction). Residual data R associated with the first encoding would not match (or “align”) with the base video stream B of the second encoding. Similarly, residual data R associated with the second encoding would not match with the base video stream B of the first encoding. As such, even if a decoder had access to a base video stream B from one of the first and second encodings of the first input signal I₁, they would need the corresponding residual data R from that sane encoding to generate a matched (or “aligned”) reconstruction of the first input signal I₁.

Additionally, the first and second encodings may use different codecs, for example to encode the residual data R. If a decoder uses an incorrect codec to decode residual data R (for example if the decoder uses a codec used for a different encoding), then any reconstruction of the first input signal I₁ may also not match the first input signal I₁.

The shift-amount may be a small number, for example three or less. The shift-direction may be up, down, left, right or otherwise.

By using a small shift, the residual values can be kept relatively small, for efficient encoding, while still enabling content protection.

In this example, the shift modifier shifts the first input signal I₁ to generate the modified input signal I_{M}, which is then down-sampled. However, in other examples, and in a manner similar to that described above with reference to FIG. 4, the first input signal I₁ is down-sampled and the shift modifier shifts the resulting down-sampled signal (potentially multiple times for different encodings using different shifts).

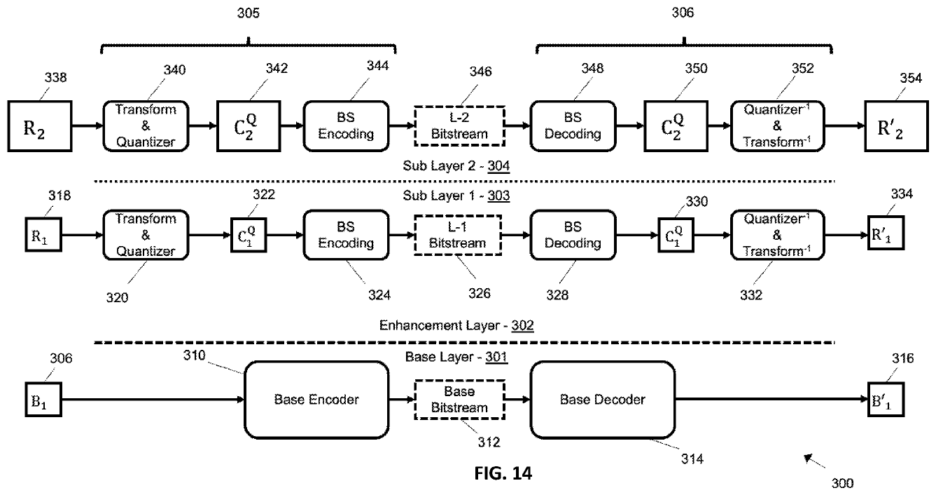

FIG. 14 shows an alternative representation of a scalable encoding scheme in the form of example signal coding system 300. The signal coding system 300 is a multi-layer or tier-based coding system, in that a signal is encoded via a plurality of bitstreams that each represent different encodings of the signal at different levels of quality (e.g., different spatial resolutions). In the example of FIG. 14, there is a base layer 301 and an enhancement layer 302. The enhancement layer 302 (and the above-described enhancement layers) may implement an enhancement coding scheme such as LCEVC. LCEVC is described in PCT/GB2020/050695, and the associated standard specification documents including the Text of ISO/IEC 23094-2 Ed 1 Low Complexity Enhancement Video Coding published in November 2021. Both of these documents are incorporated herein by reference. As per the examples of FIGS. 1, 2, 4, 6, 8, 9 and 11, in FIG. 14, the enhancement layer 301 comprises two sub-layers: a first sub-layer 303 and a second sub-layer 304. Each layer and sub-layer may be associated with a specific level of quality. Level of quality as used herein may refer to one or more of: sampling rate, spatial resolution, and bit depth, amongst others. In LCEVC, the base layer 301 is at a base level of quality, the first sub-layer 303 is at a first level of quality and the second sub-layer 304 is at a second level of quality. The base level of quality and the first level of quality may comprise a common (i.e., shared or same) level of quality or different levels of quality. In a case where the levels of quality correspond to different spatial resolutions, such as in LCEVC, inputs for each level of quality may be obtained by down-sampling and/or up-sampling from another level of quality. For example, the first level of quality may be at a first spatial resolution and the second level of quality may be at a second, higher spatial resolution, where signals may be converted between the levels of quality by down-sampling from the second level of quality to the first level of quality and by up-sampling from the first level of quality to the second level of quality.

In FIG. 14, corresponding encoder 305 and decoder 306 portions of the signal coding system 300 are illustrated. It will be noted that the encoder 305 and the decoder 306 may be implemented as separate products and that these need not originate from the same manufacturer or be provided as a single combined unit. The encoder 305 and decoder 306 are typically implemented in different geographic locations, such that an encoded data stream is generated in order to communicate an input signal between said two locations. Each of the encoder 305 and the decoder 306 may be implemented as part of one or more codecs—hardware and/or software entities able to encode and decode signals. Reference to communication of signals as described herein also covers encoding and decoding of files, wherein the communication may be within time on a common machine (e.g., by generating an encoded file and accessing it at a later point in time) or via physical transportation on a medium between two devices.

In certain preferred implementations, the components of the base layer 301 may be supplied separately to the components of the enhancement layer 302; for example, the base layer 301 may be implemented by hardware-accelerated codecs whereas the enhancement layer 302 may comprise a software-implemented enhancement codec. The base layer 301 comprises a base encoder 310. The base encoder 310 receives a version of an input signal to be encoded 306, for example a signal following one or two rounds of down-sampling and generates a base bitstream 312. The base bitstream 312 is communicated between the encoder 305 and decoder 306. At the decoder 306, a base decoder 314 decodes the base bitstream 312 to generate a reconstruction of the input signal at the base level of quality 316.

Both enhancement sub-layers 303 and 304 comprise a common set of encoding and decoding components. The first sub-layer 303 comprises a first sub-layer transformation and quantisation component 320 that outputs a set of first sub-layer transformed coefficients 322. The first sub-layer transformation and quantisation component 320 receives data 318 derived from the input signal at the first level of quality and applies a transform operation. This data may comprise the first set of residuals as described above. The first sub-layer transformation and quantisation component 320 may also apply a variable level of quantisation to an output of the transform operation (including being configured to apply no quantisation). Quality scalability may be applied by varying the quantisation that is applied in one or more of the enhancement sub-layers. The set of first sub-layer transformed coefficients 322 are encoded by a first sub-layer bitstream encoding component 324 to generate a first sub-layer bitstream 326. This first sub-layer bitstream 326 is communicated from the encoder 305 to the decoder 306. At the decoder 306, the first sub-layer bitstream 326 is received and decoded by a first sub-layer bitstream decoder 328 to obtain a decoded set of first sub-layer transformed coefficients 330. The decoded set of first sub-layer transformed coefficients 330 are passed to a first sub-layer inverse transformation and inverse quantisation component 332. The first sub-layer inverse transformation and inverse quantisation component 332 applies further decoding operations including applying at least an inverse transform operation to the decoded set of first sub-layer transformed coefficients 330. If quantisation has been applied by the encoder 305, the first sub-layer inverse transformation and inverse quantisation component 332 may apply an inverse quantisation operation prior to the inverse transformation. The further decoding is used to generate a reconstruction of the input signal. In one case, the output of the first sub-layer inverse transformation and inverse quantisation component 332 is the reconstructed first set of residuals 334 that may be combined with the reconstructed base stream 316 as described above.

In a similar manner, the second sub-layer 304 also comprises a second sub-layer transformation and quantisation component 340 that outputs a set of second sub-layer transformed coefficients 342. The second sub-layer transformation and quantisation component 340 receives data derived from the input signal at the second level of quality and applies a transform operation. This data may also comprise residual data 338 in certain embodiments, although this may be different residual data from that received by the first sub-layer 303, e.g., it may comprise the further set of residuals as described above. The transform operation may be the same transform operation that is applied at the first sub-layer 303. The second sub-layer transformation and quantisation component 340 may also apply a variable level of quantisation before the transform operation (including being configured to apply no quantisation). The set of second sub-layer transformed coefficients 342 are encoded by a second sub-layer bitstream encoding component 344 to generate a second sub-layer bitstream 346. This second sub-layer bitstream 346 is communicated from the encoder 305 to the decoder 306. In one case, at least the first and second sub-layer bitstreams 326 and 346 may be multiplexed into a single encoded data stream. In one case, all three bitstreams 312, 326 and 346 may be multiplexed into a single encoded data stream. The single encoded data stream may be received at the decoder 306 and de-multiplexed to obtain each individual bitstream.

At the decoder 306, the second sub-layer bitstream 346 is received and decoded by a second sub-layer bitstream decoder 348 to obtain a decoded set of second sub-layer transformed coefficients 350. As above, the decoding here relates to a bitstream decoding and may form part of a decoding pipeline (i.e., the decoded set of transformed coefficients 330 and 350 may represent a partially decoded set of values that are further decoded by further operations). The decoded set of second sub-layer transformed coefficients 350 are passed to a second sub-layer inverse transformation and inverse quantisation component 352. The second sub-layer inverse transformation and inverse quantisation component 352 applies further decoding operations including applying at least an inverse transform operation to the decoded set of second sub-layer transformed coefficients 350. If quantisation has been applied by the encoder 305 at the second sub-layer, the inverse second sub-layer transformation and inverse quantisation component 352 may apply an inverse quantisation operation prior to the inverse transformation. The further decoding is used to generate a reconstruction of the input signal. This may comprise outputting a reconstruction of the further set of residuals 354 for combination with an up-sampled combination of the reconstruction of the first set of residuals 334 and the base stream 316 (e.g., as described above).

The bitstream encoding components 324 and 344 may implement a configurable combination of one or more of entropy encoding and run-length encoding. Likewise, the bitstream decoding components 328 and 348 may implement a configurable combination of one or more of entropy encoding and run-length decoding.

Further details and examples of a two sub-layer enhancement encoding and decoding system may be obtained from published LCEVC documentation.

In general, examples described herein operate within encoding and decoding pipelines that comprises at least a transform operation. The transform operation may comprise the DCT or a variation of the DCT, a Fast Fourier Transform (FFT), or a Hadamard transform as implemented by LCEVC. The transform operation may be applied on a block-by-block basis. For example, an input signal may be segmented into a number of different consecutive signal portions or blocks and the transform operation may comprise a matrix multiplication (i.e., linear transformation) that is applied to data from each of these blocks (e.g., as represented by a 1D vector). In this description and in the art, a transform operation may be said to result in a set of values for a predefined number of data elements, e.g., representing positions in a resultant vector following the transformation. These data elements are known as transformed coefficients (or sometimes simply “coefficients”).

As described herein, where the signal data comprises residual data, a reconstructed set of coefficient bits may comprise transformed residual data, and a decoding method may further comprise instructing a combination of residual data obtained from the further decoding of the reconstructed set of coefficient bits with a reconstruction of the input signal generated from a representation of the input signal at a lower level of quality to generate a reconstruction of the input signal at a first level of quality. The representation of the input signal at a lower level of quality may be a decoded base signal (e.g., from base decoder 314) and the decoded base signal may be optionally upscaled before being combined with residual data obtained from the further decoding of the reconstructed set of coefficient bits, the residual data being at a first level of quality (e.g., a first resolution). Decoding may further comprise receiving and decoding residual data associated with a second sub-layer 304, e.g., obtaining an output of the inverse transformation and inverse quantisation component 352, and combining it with data derived from the aforementioned reconstruction of the input signal at the first level of quality. This data may comprise data derived from an upscaled version of the reconstruction of the input signal at the first level of quality, i.e., an upscaling to the second level of quality.

Although examples have been described with reference to a tier-based hierarchical coding scheme in the form of LCEVC, the methods described herein may also be applied to other tier-based hierarchical coding scheme, such as VC-6: SMPTE VC-6 ST-2117 as described in PCT/GB2018/053552 and/or the associated published standard document, which are both incorporated by reference herein.

FIG. 15 shows how a video signal may be decomposed into different components and then encoded. In the example of FIG. 15, a video signal 402 is encoded. The video signal 402 comprises a plurality of frames or pictures 404, e.g., where the plurality of frames represent action over time. In this example, each frame 404 is made up of three colour components. The colour components may be in any known colour space. In FIG. 15, the three colour components are Y (luma), U (a first chroma opponent colour) and V (a second chroma opponent colour). Each colour component may be considered a plane 408 of values. The plane 408 may be decomposed into a set of n by n blocks of signal data 410. For example, in LCEVC, n may be 2 or 4; in other video coding technologies n may be 8 to 32.

In some examples, the to-be-modified signal described above comprises a luminance component (e.g., the Y component)) and chrominance components (e.g., the U and V components). In some such examples, the luminance component of the to-be-modified signal is modified based on the modification signal. However, the chrominance components of the to-be-modified signal are not modified based on the modification signal. Modifying only the luminance component can still produce the visual artefacts described herein. However, modifying only the luminance component can result in less processing than modifying all three components, while still providing the desired content protection.

In LCEVC and certain other coding technologies, a video signal fed into a base layer such as 301 is a downscaled version of the input video signal 302. In this case, the signal that is fed into both sub-layers comprises a residual signal comprising residual data. A plane of residual data may also be organised in sets of n by n blocks of signal data 410. The residual data may be generated by comparing data derived from the input signal being encoded, e.g., the video signal 402, and data derived from a reconstruction of the input signal, the reconstruction of the input signal being generated from a representation of the input signal at a lower level of quality. In the example of FIG. 14, the reconstruction of the input signal may comprise a decoding of the encoded base bitstream 312 that is available at the encoder 305. This decoding of the encoded base bitstream 312 may comprise a lower resolution video signal that is then compared with a video signal down-sampled from the input video signal 402. The comparison may comprise subtracting the reconstruction from the down-sampled version. The comparison may be performed on a frame-by-frame (and/or block-by-block) basis. The comparison may be performed at the first level of quality; if the base level of quality is below the first level of quality, a reconstruction from the base level of quality may be upscaled prior to the comparison. In a similar manner, the input signal to the second sub-layer, e.g., the input for the second sub-layer transformation and quantisation component 340, may comprise residual data that results from a comparison of the input video signal 402 at the second level of quality (which may comprise a full-quality original version of the video signal) with a reconstruction of the video signal at the second level of quality. As before, the comparison may be performed on a frame-by-frame (and/or block-by-block) basis and may comprise subtraction. The reconstruction of the video signal may comprise a reconstruction generated from the decoded decoding of the encoded base bitstream 312 and a decoded version of the first sub-layer residual data stream. The reconstruction may be generated at the first level of quality and may be up-sampled to the second level of quality.

Hence, a plane of data 408 for the first sub-layer 303 may comprise residual data that is arranged in n by n signal blocks 410. One such 2 by 2 signal block is shown in more detail in FIG. 15 (n is selected as 2 for ease of explanation) where for a colour plane the block may have values 412 with a set bit length (e.g., 8 or 16-bit). Each n by n signal block may be represented as a flattened vector 414 of length n² representing the blocks of signal data. To perform the transform operation, the flattened vector 414 may be multiplied by a transform matrix 416 (i.e., the dot product taken). This then generates another vector 418 of length n² representing different transformed coefficients for a given signal block 410. FIG. 15 shows an example similar to LCEVC where the transform matrix 416 is a Hadamard matrix of size 4 by 4, resulting in a transformed coefficient vector 418 having four elements with respective values. These elements are sometimes referred to by the letters A, H, V and D as they may represent an average, horizontal difference, vertical difference and diagonal difference. Such a transform operation may also be referred to as a directional decomposition. When n=4, the transform operation may use a 16 by 16 matrix and be referred to as a directional decomposition squared.

As shown in FIG. 15, the set of values for each data element across the complete set of signal blocks 410 for the plane 408 may themselves be represented as a plane or surface of coefficient values 420. For example, values for the “H” data elements for the set of signal blocks may be combined into a single plane, where the original plane 408 is then represented as four separate coefficient planes 422. For example, the illustrated coefficient plane 422 contains all the “H” values. These values are stored with a predefined bit length, e.g., a bit length B, which may be 8, 16, 32 or 64 depending on the bit depth. A 16-bit example is considered below but this is not limiting. As such, the coefficient plane 422 may be represented as a sequence (e.g., in memory) of 16-bit or 2-byte values 424 representing the values of one data element from the transformed coefficients. These may be referred to as coefficient bits.

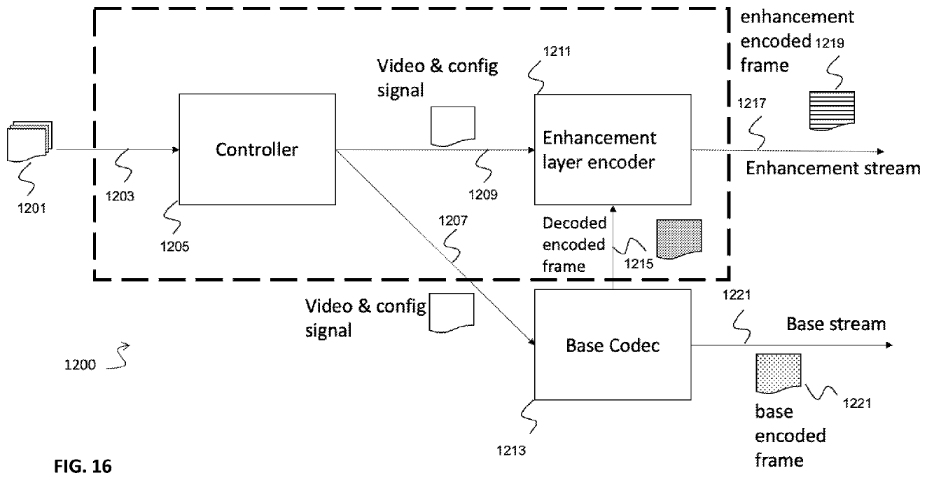

FIG. 16 shows an example encoder that may be configured to perform any of the methods described herein.

FIG. 16 shows an example encoder 1200 comprising a controller 1205 to receive (1203) at least one input signal 1201. The controller 1205 may receive one input signal 1201, two input signals 1201, three input signals 1201, or more than three input signals 1201. The controller 1205 is communicatively coupled to a base encoder 1213 and an enhancement encoder 1211. The controller 1205 is configured to make some or all of the at least one input signals 1201 (and/or one or more signals derived from the at least one input signal 1201) and a base encoding configuration 1207 available to the base encoder and to make some or all of the at least one input signals 1201 (and/or one or more signals derived from the at least one input signal 1201) and an enhancement encoding configuration 1209 available to the enhancement encoder 1211. The enhancement encoder 1211 receives a decoding 1215 of an output of the base encoder as applied to the input video to perform an enhancement encoding of the input video. In FIG. 15, the base encoder 1213 forms part of a base codec that includes base encoder and base decoder components (although these may be provided separately). The base encoder 1213 generate an encoded base stream 1221 and the enhancement encoder generates an encoded enhancement stream 1217.

The techniques described herein may be implemented in software or hardware, or may be implemented using a combination of software and hardware. They may include configuring an apparatus to carry out and/or support any or all of techniques described herein.

The above examples are to be understood as illustrative. Further examples are envisaged.

For example, although examples described above relate primarily to image or video signals, the spatially scalable coding schemes and systems described herein may be applied to audio signals. In such cases, an audio signal may be modified, for example, by adding noise. The audio signal may be recoverable at a base level but with the added noise present. The audio signal may be recoverable at an enhancement level but with the added noise removed.

It is to be understood that any feature described in relation to any one example may be used alone, or in combination with other features described, and may also be used in combination with one or more features of any other of the examples, or any combination of any other of the examples. Furthermore, equivalents and modifications not described above may also be employed without departing from the scope of the invention, which is defined in the accompanying claims.

The following sets out particularly preferred examples of the present disclosure as a set of numbered clauses. It will be understood that these are examples helpful in understanding the invention.

Numbered Clause 1. A method comprising:
modifying a to-be-modified signal using a modification signal to produce a modified signal, wherein the modification signal comprises a watermark, wherein the modified signal has an element corresponding to an element of the to-be-modified signal, and wherein the element of the modified signal has a modified value with respect to a value of the corresponding element of the to-be-modified signal;
sending the modified signal, or a down-sampled modified signal derived based on down-sampling the modified signal, to be encoded;
receiving a decoded modified signal, the decoded modified signal being a decoded version of the modified signal as encoded or of the down-sampled modified signal as encoded, wherein an effect of the modification is visible in the decoded modified signal;
using the decoded modified signal to generate a processed signal; and generating residual data based at least on:
a value of an element of a target signal; and
a value of a corresponding element of the processed signal,
wherein the processed signal and the residual data are combinable to generate a reconstructed signal, and
wherein the effect of the modification is not visible in the reconstructed signal.

Numbered Clause 2. A method according to Numbered Clause 1, comprising:
down-sampling the modified signal to produce the down-sampled modified signal; and
sending the down-sampled modified signal to be encoded.

Numbered Clause 3. A method according to Numbered Clause 2, wherein the target signal comprises the to-be-modified signal.

Numbered Clause 4. A method according to Numbered Clause 3, comprising sending the residual data, or data derived based on the residual data, to be encoded.

Numbered Clause 5. A method according to any of Numbered Clauses 2 to 4, comprising generating correction data based on:
a value of an element of the down-sampled modified signal;
a value of a corresponding element of the decoded modified signal; and
a value of a corresponding element of the modification signal or a value of a corresponding element of a signal based on the modification signal.

Numbered Clause 6. A method according to Numbered Clause 5, comprising deriving said signal based on the modification signal by processing the modification signal.

Numbered Clause 7. A method according to Numbered Clause 5 or 6, comprising:
sending the correction data, or data derived based on the correction data, to be encoded.

Numbered Clause 8. A method according to Numbered Clause 2, wherein the target signal comprises the modified signal.

Numbered Clause 9. A method according to Numbered Clause 8, comprising:
generating further residual data based on:
a value of an element of the residual data; and
a value of a corresponding element of the modification signal or a value of a corresponding element of a signal based on the modification signal.

Numbered Clause 10. A method according to Numbered Clause 9, comprising deriving said signal based on the modification signal by processing the modification signal.

Numbered Clause 11. A method according to Numbered Clause 9 or 10, comprising:
sending the further residual data, or data derived based on the further residual data, to be encoded.

Numbered Clause 12. A method according to Numbered Clause 1, wherein the target signal comprises a to-be-down-sampled signal.

Numbered Clause 13. A method according to Numbered Clause 12, comprising down-sampling the to-be-down-sampled signal to derive the to-be-modified signal.

Numbered Clause 14. A method according to any of Numbered Clauses 1 to 13, wherein the modification signal comprises an overlay to be applied to the to-be-modified signal.

Numbered Clause 15. A method according to any of Numbered Clauses 1 to 14, wherein the modified signal has another element corresponding to another element of the to-be-modified signal, and wherein the other element of the modified signal has the same value as the value of the corresponding other element of the to-be-modified signal.

Numbered Clause 16. A method according to any of Numbered Clauses 1 to 15, wherein the modifying of the to-be-modified signal comprises combining the to-be-modified signal with the modification signal.

Numbered Clause 17. A method according to any of Numbered Clauses 1 to 16, wherein the to-be-modified signal comprises a luminance component and chrominance components, wherein the luminance component of the to-be-modified signal is modified based on the modification signal, and wherein the chrominance components of the to-be-modified signal are not modified based on the modification signal.

Numbered Clause 18. A method according to any of Numbered Clauses 1 to 17, wherein the using of the decoded modified signal to generate the processed signal comprises performing an up-sampling operation.

Numbered Clause 19. A method comprising:
processing a decoded modified signal to obtain a processed signal; and
combining the processed signal and residual data to generate a reconstructed signal,
wherein the decoded modified signal is a decoded version of a modified signal as encoded or of a down-sampled modified signal as encoded, the down-sampled modified signal having been derived based on the modified signal having been down-sampled,
wherein the modified signal has been produced based on a to-be-modified signal having been modified using a modification signal, the modification signal comprising a watermark,
wherein the modified signal has an element corresponding to an element of the to-be-modified signal, and
wherein the element of the modified signal has a modified value with respect to a value of the corresponding element of the to-be-modified signal,
wherein an effect of the modification is visible in the decoded modified signal, and
wherein the effect of the modification is not visible in the reconstructed signal.

Numbered Clause 20. A method according to any of Numbered Clauses 1 to 19, wherein the element of the modified signal and the corresponding element of the to-be-modified signal are pixels.

Numbered Clause 21. Apparatus configured to perform a method according to any of Numbered Clauses 1 to 20.

Numbered Clause 22. A computer program arranged, when executed, to perform a method according to any of Numbered Clauses 1 to 20.

Numbered Clause 23. A data stream comprising:
an encoded version of a modified signal or an encoded version of a down-sampled modified signal, the down-sampled modified signal having been derived based on the modified signal having been down-sampled; and
encoded residual data,
wherein the modified signal has been produced based on a to-be-modified signal having been modified using a modification signal, the modification signal comprising a watermark,
wherein the modified signal has an element corresponding to an element of the to-be-modified signal,
wherein the element of the modified signal has a modified value with respect to a value of the corresponding element of the to-be-modified signal,
wherein a decoded modified signal is processable to obtain a processed signal, the decoded modified signal being a decoded version of the modified signal as encoded or of the down-sampled modified signal as encoded,
wherein the processed signal and the residual data are combinable to generate a reconstructed signal,
wherein an effect of the modification is visible in the decoded modified signal, and
wherein the effect of the modification is not visible in the reconstructed signal.

1-27. (canceled)

28. A method comprising:
modifying a to-be-modified signal using a modification signal to produce a modified signal, wherein the modified signal has an element corresponding to an element of the to-be-modified signal, and wherein the element of the modified signal has a modified value with respect to a value of the corresponding element of the to-be-modified signal;
sending the modified signal, or a down-sampled modified signal derived based on down-sampling the modified signal, to be encoded;
receiving a decoded modified signal, the decoded modified signal being a decoded version of the modified signal as encoded or of the down-sampled modified signal as encoded;
using the decoded modified signal to generate a processed signal; and generating residual data based at least on:
a value of an element of a target signal; and
a value of a corresponding element of the processed signal.

29. The method according to claim 28, comprising:
down-sampling the modified signal to produce the down-sampled modified signal; and
sending the down-sampled modified signal to be encoded.

30. The method according to claim 29, wherein the target signal comprises the to-be-modified signal.

31. The method according to claim 30, comprising sending the residual data, or data derived based on the residual data, to be encoded.

32. The method according claim 29, comprising generating correction data based on:
a value of an element of the down-sampled modified signal;
a value of a corresponding element of the decoded modified signal; and
a value of a corresponding element of the modification signal or a value of a corresponding element of a signal based on the modification signal.

33. The method according to claim 32, comprising deriving said signal based on the modification signal by processing the modification signal.

34. The method according to claim 32, comprising:
sending the correction data, or data derived based on the correction data, to be encoded.

35. The method according claim 29, wherein the target signal comprises the modified signal.

36. A method according to claim 35, comprising:
generating further residual data based on:
a value of an element of the residual data; and
a value of a corresponding element of the modification signal or a value of a corresponding element of a signal based on the modification signal.

37. The method according claim 36, comprising deriving said signal based on the modification signal by processing the modification signal.

38. The method according claim 36, comprising:
sending the further residual data, or data derived based on the further residual data, to be encoded.

39. The method according claim 28, wherein the target signal comprises a to-be-down-sampled signal, wherein the to-be-down-sampled signal is down-sampled to derive the to-be-modified signal.

40. The method according claim 28, wherein the modification signal comprises one of an overlay to be applied to the to-be-modified signal or a watermark.

41. The method according claim 28, wherein the modified signal has another element corresponding to another element of the to-be-modified signal, and wherein the other element of the modified signal has the same value as the value of the corresponding other element of the to-be-modified signal.

42. The method according claim 28, wherein the modifying of the to-be-modified signal comprises combining the to-be-modified signal with the modification signal.

43. The method according claim 28, wherein the modifying of the to-be-modified signal comprises shifting a position of one or more values of the to-be-modified signal within the to-be-modified signal based on the modification signal.

44. The method according claim 28, wherein the to-be-modified signal comprises a luminance component and chrominance components, wherein the luminance component of the to-be-modified signal is modified based on the modification signal, and wherein the chrominance components of the to-be-modified signal are not modified based on the modification signal.

45. The method according claim 28, wherein the using of the decoded modified signal to generate the processed signal comprises performing an up-sampling operation.

46. A method comprising:
processing a decoded modified signal to obtain a processed signal; and combining the processed signal and residual data to generate a reconstructed signal,
wherein the decoded modified signal is a decoded version of a modified signal as encoded or of a down-sampled modified signal as encoded, the down-sampled
modified signal having been derived based on the modified signal having been down-sampled,
wherein the modified signal has been produced based on a to-be-modified signal having been modified using a modification signal,
wherein the modified signal has an element corresponding to an element of the to-be-modified signal, and
wherein the element of the modified signal has a modified value with respect to a value of the corresponding element of the to-be-modified signal.

47. An apparatus comprising:
a processor;
a non-transitory computer readable storage device having stored thereon computer executable instructions that, when executed by the processor, cause the apparatus to perform the following:
modifying a to-be-modified signal using a modification signal to produce a modified signal, wherein the modified signal has an element corresponding to an element of the to-be-modified signal, and wherein the element of the modified signal has a modified value with respect to a value of the corresponding element of the to-be-modified signal;
sending the modified signal, or a down-sampled modified signal derived based on down-sampling the modified signal, to be encoded;
receiving a decoded modified signal, the decoded modified signal being a decoded version of the modified signal as encoded or of the down-sampled modified signal as encoded;
using the decoded modified signal to generate a processed signal; and generating residual data based at least on:
a value of an element of a target signal; and
a value of a corresponding element of the processed signal.
